(19) United States
(12) Patent Application Publication
(10) Pub. No.: US 2006/0156553 A1
(43) Pub. Date: Jul. 20, 2006

(54) Device to facilitate the opening of condiment packages

(76) Inventor: Maria Victoria Ensenat Alvarez, Madrid (ES)

Correspondence Address: WILLIAM COLLARD;COLLARD & ROE, P.C., 1077 NORTHERN BOULEVARD, ROSLYN, NY, 11576, US

(21) Appl. No.: 11/334,283

(22) Filed: Jan. 18, 2006

(30) Foreign Application Priority Data
Jan. 18, 2005 (ES) P200500091

(51) Int. Cl. B26B 3/00

(52) U.S. Cl. 30/280; 30/294

(57) ABSTRACT

The present invention refers to a device to facilitate the opening of condiment packages wherein it includes a carcase equipped with areas for the placement of advertising, which carcase is equipped with a slot into which the end of the condiment package is introduced and a knife inside the carcase which cuts the end of the package.

### OBJECT OF THE INVENTION

The present invention refers to a device to facilitate the opening of condiment packages.

### BACKGROUND OF THE INVENTION

It is frequent nowadays in fast food restaurants, cafeterias and restaurants, for example, to serve certain condiments such as tomato ketchup, mustard, mayonnaise and similar in individual packages.

These packages have a plastic and highly resistant consistency for their size, in addition to a small perimetrical sealed wing which makes them difficult to grasp and tear the package open. This often makes it difficult, if not impossible, to open the package and can also result in splattering and/or staining.

To facilitate the opening process, some of these packages have perimetrical indentations, which in many cases do not work satisfactorily.

These inconveniences are remedied by using the device of the invention.

### DESCRIPTION OF THE INVENTION

The device of the invention has an ideal constitution to facilitate the opening of condiment packages.

According to the invention, the device consists of an ergonomically shaped carcase that can be grasped with the hand or which can be placed on or fastened to a table or wall and also contains some visible surfaces intended to be used for advertising or similar information which can be printed on by silk screening, tampography, pasting, etc.

The carcase is equipped with a slot where the end of the condiment package is introduced in order to be cut or guillotined so that the product can be extracted.

Inside the carcase there is a knife which cuts the end of the condiment package introduced into the slot. Obviously, the size of the slot is such that the end of the condiment package fits inside while the user's fingers do not, even if the user is a child.

The knife can be fixed, in which case the end of the condiment package is run along the length of the slot in order to cut the plastic, or it can be mobile and associated with a structure that includes an activation control equipped with a recovery spring to produce the cutting of this part of the package by activating the control. In this case, it would not be necessary to run the edge of the package along the slot but rather to position it properly inside the slot.

### BRIEF DESCRIPTION OF THE DRAWINGS

FIGS. 1, 2 and 3 show a perspective view, a ground view and a cross section of a variation of the embodiment of the device of the invention.

FIGS. 4, 5 and 6 show a perspective view, a ground view and an elevation view of another variation of the embodiment of the device of the invention.

### DESCRIPTION OF A PRACTICAL EMBODIMENT OF THE INVENTION

The device 1 of the invention includes a carcase 2, preferably ergonomically shaped to facilitate grasping and equipped with areas 3 for the placement of advertising information which may be printed by silk screening, tampography, pasted, etc.

The carcase is equipped with a slot 4 of a sufficient dimension to allow the end of the condiment package 5 to be introduced for opening, but which is not large enough to allow other objects, such as the user's fingers, to be introduced.

Inside the carcase there is a knife 6 which cuts the end of the condiment package introduced into the slot.

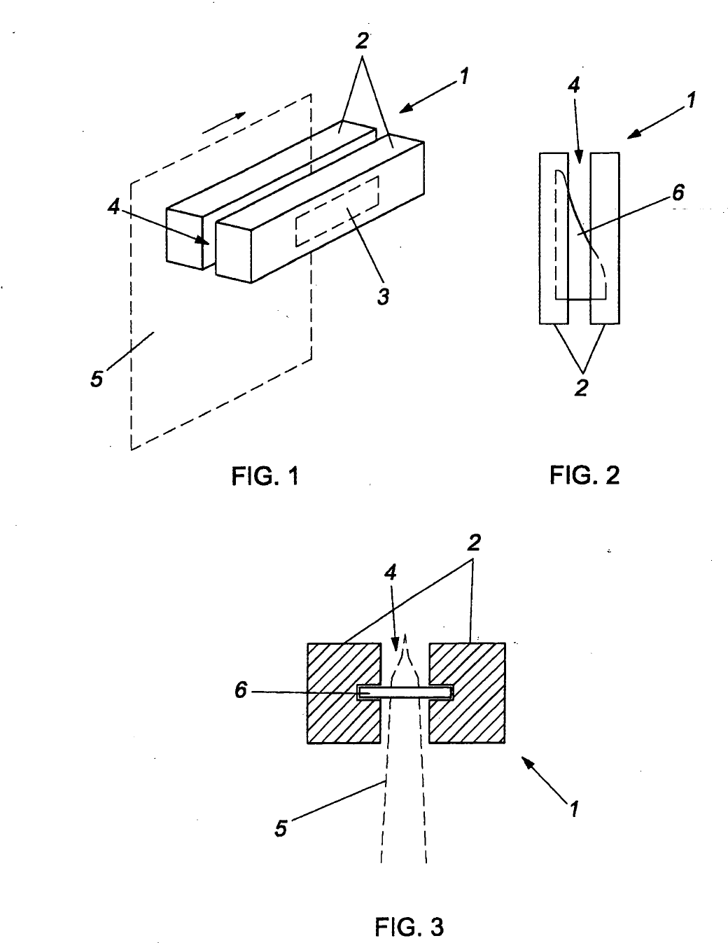

The knife 6 can be fixed or mobile. In the first case, which is shown in FIGS. 1, 2 and 3, the knife 6 adopts a perpendicular and obliquely secant position with respect to the projection of the slot, so that by sliding the package in the right direction along the slot, the knife will cut the end of the package.

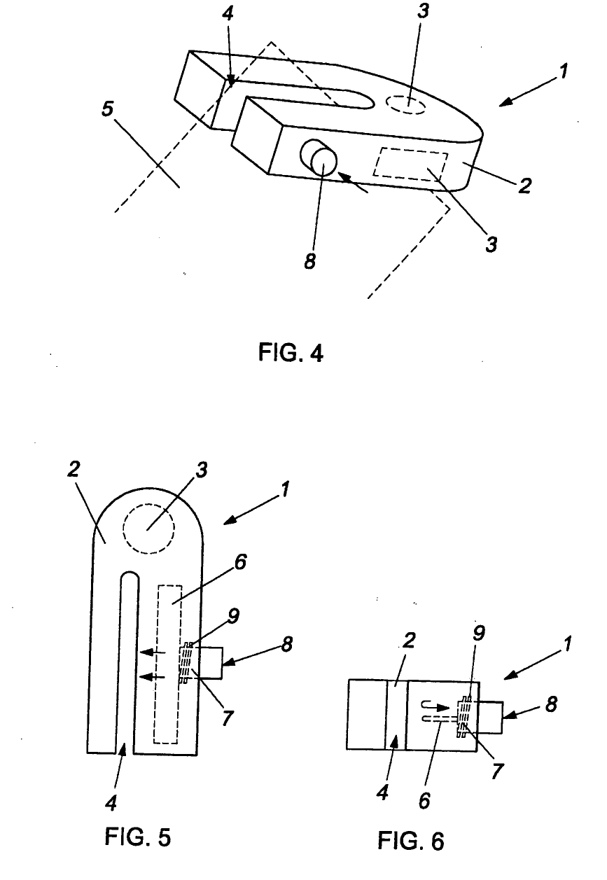

In the second case, which is shown in FIGS. 4, 5 and 6, the knife is mounted on a moving structure 7 which is accessed from the outside of the carcase configuring an activating control 8. This structure is associated with a recovery spring 9 which keeps it, along with the knife, retracted on the projection of the slot 4. When the end of the condiment package is inserted into the slot and the control 8 is activated, the knife advances perpendicularly over the projection of the slot, cutting the end of the package introduced in the slot and thereby opening the package. When the control is released, the knife retracts to its initial position by the action of the recovery spring.

Obviously, the shape of the carcase can vary, the slot preferably adopting open forms such as those depicted in the drawings to favour the extraction of the cut end of the condiment package. However, other configurations are also possible such as, for example those in which the cut portion of the package is collected in a receptacle or similar.

As a variation of the embodiment of the invention, not represented in the drawings, the carcase can be equipped with a weighted base which can be placed on a table or can be equipped with a device for directly fastening the device to a table or to a wall or division.

Having described the nature and the practical embodiment of the invention sufficiently, it should be noted that certain details of the provisions indicated above and represented in the enclosed drawings are subject to change, although the basic principal will remain unaltered.

1. A device to facilitate the opening of condiment packages wherein it includes a carcase equipped with areas for the placement of advertising, which carcase is equipped with a slot into which the end of the condiment package is introduced and a knife inside the carcase which cuts the end of the package.

2. A device according to claim 1, wherein the knife is fixed, adopting a considerably perpendicular and obliquely secant position to the projection of the slot in order to cut the end of the package as it is run through the slot.

3. A device according to claim 1, wherein the knife is mounted on a moving structure which accesses through the outside of the carcase configuring an activating control and which is in turn associated with a recovery spring that keeps the knife in a retracted position over the projection of the slot, with the knife advancing along the projection when the control is activated in order to cut the end of the package previously introduced into the slot.

4. A device according to claim 1, wherein the carcase is ergonomically shaped to facilitate grasping and handling.

5. A device according to claim 1, wherein the carcase is equipped with a base for setting the device on a horizontal surface such as a table.

6. A device according to claim 1, wherein the carcase is equipped with media for directly fastening the device to a surface such as a table, panel or division.
